(19) United States
(12) Patent Application Publication
(10) Pub. No.: US 2022/0349698 A1
(43) Pub. Date: Nov. 3, 2022

(54) Overcoming uncertainty

(71) Applicant: James D. Welch, Oamha, NE (US)

(72) Inventor: James D. Welch, Oamha, NE (US)

(21) Appl. No.: 17/803,374

(22) Filed: Jun. 6, 2022

Related U.S. Application Data
(60) Provisional application No. 63/327,015, filed on Apr. 4, 2022.

(51) Int. Cl. G01B 9/02

(52) U.S. Cl. CPC G01B 9/02

(57) ABSTRACT

A method of accurately measuring Time, and knowing the Energy in a Beam of Electromagnetic Radiation simultaneously.

### TECHNICAL FIELD

The present invention relates to Heisenberg's Uncertainty Principle, and more particularly to a method of knowing both Time and Energy in a Beam of Electromagnetic Radiation simultaneously.

### BACKGROUND

It is well known in Quantum Mechanics that the Principle of Complementarity holds that there are pairs of variables that cannot both be measured simultaneously, for instance, a Particle's Position and Momentum. This can be appreciated as when one measures a particles position, it is known where it is at an instant, but it could be simply resting there or it could be moving at near the speed of light, or any velocity (Momentum) in between. And when Momentum is measure it is required to monitor at two positions and determine how long it took for the Particle to transvers the distance between them. There is no definite single Position.

Another example of such Complimentary variables involves Energy and Time. It must be appreciated here that Energy in an Electromagnetic Beam is a function of Wavelength. As the Wavelength of a Beam of Electromagnetic Radiation decreases the Energy thereof increases. A situation then is present that to know the Energy one must know Wavelength, and it takes at least the Time of one Cycle of oscillation to determine such. Therefore Time must pass while monitoring the Energy and there is no distinct Time at which the Energy is determined. One can measure Time per se., but then Energy is not known. There seems to be no way out of the “squirrel cage”. The present invention proposes a way to possibly escape from the above Squirrel Cage situation, at least in a practical sense. Not by claiming that the Quantum Mathematics is internally inconsistent etc. (which it is not), but by proposing an experiment that would lead to a contradiction as to what the Uncertainty Principal demands, and what can be known.

Known prior art in the area are Published Patent Applications by the Inventor herein: 2005/0168748; 2010/0243917; 2010/0116096; 2011/0291006; and 2016/0252541. The last reference presented the idea that a moving particle or photon has a wave associated with it, and in a Double Slit System that wave passes through both Slits and forms an Interference Field thereafter. A particle or photon passing through a Slit is influenced thereby, possibly via refraction effects, which are determined by where within the Width of the slit it passes. Bohm's Quantum Potential is also based on*that where-within-the-slit a particle passes. The contention here, however, is that if that path is coincident with a pathway of positive phase addition in the Interference Field it continues to propagate, but if that pathway it is directed into is one of negative phase addition, it stops. This, again, is a bit like Bohm's (and deBroglie's) Pilot Wave idea, but does not rely on a Quantum Potential to act as a particle or photon guide. The present scenario is simpler in that pathways of various phase addition attributes simply present after the slits when a wave passes therethrough, and all that is required is that a particle or photon be directed along one to determine its fate. Again, if the pathway happens to be one of positive phase addition the particle of photon continues to propagate, and if the pathway is one of negative pathway is one of negative phase addition it stops propagating. It is possible that Bohm's Quantum Field is involved, but is not the sole influence. The Applicant herein has seen articles that make clear that the Bohm scenario is not at all as simple as that presently presented. Other ideas in the identified references include carrying out the Double Slot experiment in a Cloud Chamber and just watch which Slit a Particle or Photon passes. As has been pointed out to the Applicant herein on many occasions, this proposition might sound to be bit of nonsense as a particle or photon interaction with atoms etc. in the Cloud would prevent an Interference Pattern from forming. However, it is noted that such an experiment can be carried out in Air using a Laser and a Double Slit Barrier—and an Interference Pattern forms on a Wall across the way. Further, one of the identified references suggests letting the Screen on which the Interference Pattern forms move laterally during single particle firings. The amount it moves might provide some evidence as to which Slit it passed. It has been suggested to let the Barrier in which the Slits are present move, and that was dismissed by those who suggested it. But letting the Barrier upon which the Interference Pattern forms has not been suggested to the Applicant's knowledge. Of course, one would have to reset the position of the movable Barrier between experiments or an Interference Pattern would be somehow inaccurate.

Need remains for insight to how to, in a practical applications sense, overcome Time-Energy Uncertainty.

### DISCLOSURE OF THE INVENTION

The Present Invention proposes that a Source of a Beam of Electromagnetic Radiation be provided, along with a Detector thereof. The Detector, however, integrally comprises an effective Band Pass Filter at the entry thereto, said Band Pass Filter Pass Range being exactly that of an Energy/Wavelength in said Beam. In use one causes the Source, at time T1 to direct a Beam of Electromagnetic Radiation toward the Detector/Filter. At a time T2 the Detector will indicate that Electromagnetic Radiation has been detected. Time T2 is a measurement of Time (that elapsed since T1) and is not subject to any uncertainty. It is measured with “absolute” certainty, thereby delegating “infinite” uncertainty to any Energy measurement. This Time T2 measurement need not include a presentation of the measured Energy, but rather just be an indication that the electromagnetic beam has arrived at the entry to the Detector and the Energy measured by action of the Detector/Filter. The point here is that the Energy is also known at Time T2 (its value having been selected by the Band Pass Filter). The Detector provides an output indicating the arrival of the beam and at Time T2 the Energy is also known, as it could pass through the Band Pass Filter, it would not have arrived at all! That is, said Electromagnetic Beam comprised an Energy/Wavelength that was able to pass through the Band Pass Filter ahead of the Detector. It might be necessary that, in order to actually read out the detected Energy, the Beam arriving at the Detector will have to be Diffracted or Refracted or the like, but the time to do so is believed not properly a part of what Heisenberg's Principle considers as relevant. When the Beam reaches a Grating or Prism etc. to mediate its read-out, its Energy is already known at time T2. Its readout is merely a verification.

The foregoing assumes a “perfect” Band Pass Filter which simply lets a Beam of an acceptable Energy/Wavelength pass through it and arrive at the Input of the Detector at Time T2. Such a perfect Band Pass Filter is perhaps arguably a bit unrealistic, but then Heisenberg's Principle itself is based on Fourier-type Math, which itself is only a model of Reality and a bit unrealistic. The properties of the Detector/Filter are considered to be of a similar nature to the Fourier type Model. It is contended that the Time T2 is determined simultaneously with the Energy being known, when the Electromagnetic Beam impinges onto the Detector via its integral Band Pass Filter. It is considered that the portion of the Beam that passes through the Band Pass Filter is not “measured” thereby. Were it not stopped by the Detector, it would continue on substantially unaffected. (This might be analogized to how a particle or photon passing through a Slit in a Double Slit System is not considered to be measured thereby. “Measurement” is not considered to have happened until the particle or photon impacts the Screen upon which an Interference Pattern forms). Continuing, at time of measurement T2, both the Energy and Time are known as single values, with no need to wait over at least one cycle to determine Energy. The Band Pass Filter tends to that before detection at Time T2. Again, it might take some time to Read-Out the Energy value determined at Time T2, but as stated that is not considered to be relevant here. That time Delay is not of the sort Heisenberg considered, but rather just mechanics.

The focus of the Present Invention is that the Energy of an Electromagnetic beam to be considered during a Time Measurement is selected by the Band Pass Filter and that makes it possible to measure Energy along with Time at T2.

A method of determining both energy and time of measurement regarding an electromagnetic beam of radiation simultaneously, can then comprise the steps of:

a) providing a source of a beam of electromagnetic radiation;

b) providing a detector of electromagnetic radiation, said detector comprising at its entry an effective band-pass filter which only passes a wavelength in a beam of electromagnetic radiation impinging thereonto;

c) causing said source of a beam of electromagnetic radiation to direct a beam of electromagnetic radiation toward said combination detector/bandpass filter at a time T1;

d) monitoring said detector for a signal that said beam is detected at a time T2;

e) displaying the energy value of the beam of electromagnetic radiation detected at time T2.

Said Method can also involve determining what Wavelength the Band Pass Filter should pass. One approach is to provide a matrix of Detector/Filter Elements and just see which thereof provide an output, if any. Perhaps a better way is to first conduct a measurement with a simple system set up to measure Energy. Once that is known, provide a Band Pass Filter that passes the determined Wavelength, combine the Detector with said Band Pass Filter and practice the above recited Method to determine Time

In the above method, wherein step b) involves providing a plurality of detector elements each comprising, at its entry, an effective band-pass filter that passes a different wavelength than the others and monitoring which provides an output signal.

Alternatively, the above method can comprise, prior thereto, determining the wavelength at which a band pass filter passes said electromagnetic beam by conducting a measurement for energy using a system that does not contain any band pass filter, then provide a band pass filter that passes electromagnetic radiation at that wavelength.

A more comprehensive method of determining both energy and time of measurement regarding an electromagnetic beam of radiation simultaneously, comprising the steps of:
a) providing a source of a beam of electromagnetic radiation;
b) providing a detector of electromagnetic radiation;
c) causing said source of a beam of electromagnetic radiation to direct a beam of electromagnetic radiation toward said combination detector and measuring for energy;
d) providing a band pass filter that passes electromagnetic radiation at the wavelength associated with said energy determined in step c and affixing it to the input of the same detector as provided in step a) or a different detector.

Said method then continues with:
e) causing said source of a beam of electromagnetic radiation to direct a beam of electromagnetic radiation toward said combination detector/bandpass filter provided in step d) at a time T1;
f) measuring for a time T2 when said beam is detected by the detector/filter provided in step d), thereby establishing a time T2.
One can also then display the Energy via a refraction or diffraction.

The foregoing provides an approach to overcoming the problem described in the Background Section, that being determining both Energy and Time (ie. T2) simultaneously when a beam of electromagnetic radiation is monitored by a Detector in view of the Heisenberg Uncertainty Principle which prohibits doing so. One first provides a Beam of Electromagnetic Radiation of an Energy (ie. Wavelength), affixes a band pass filter to pass a determined Wavelength, and then with the resulting Detector/Filter in place causes the Source to direct a beam of electromagnetic radiation at the Detector/Filter and measures for Time (T2). This is probably as close to measuring both Energy and Time as one can get. And it works because the Energy, which takes time to establish when measured (at least one cycle) is selected for in Steps d) and e) when Time (T2) is measured. The important thing here is that Uncertainty would have it that as Time (T2) us measure exactly, the Energy must be Infinitely Uncertain. But is it?

In general it is noted that the shorter a wavelength the less time it takes to determine the Energy of a Beam. Hence at Zero Wavelength, (ie. Infinite Energy) it would be theoretically possible to measure Energy and Time simultaneously.

An alternative approach can involve use of a Beam Splitter and sending Beams to two Detectors, one being applied to measuring Time and the other Energy.

The Present Invention will be better understood by reference to the Detailed Description Section of this Specification, in conjunction with the Drawings.

### BRIEF DESCRIPTION OF THE DRAWINGS

FIG. 1 shows a Prior Art System for measuring Time of Energy of a Beam of Electromagnetic Radiation (EMB). Shown are a Source (S) and Detector (DET) of a Beam of Electromagnetic Radiation (EMB).

FIG. 2 shows a Present Invention System for measuring Time of measurement and Energy of a Beam of Electromagnetic Radiation (EMB) including a Band Pass Filter (BPF) at the Input of the Detector (DET).

FIG. 3 shows an alternate system involving a Beam Splitter (BS).

FIG. 4 shows another alternate system involving a Beam Collimating Lens.

### DETAILED DESCRIPTION

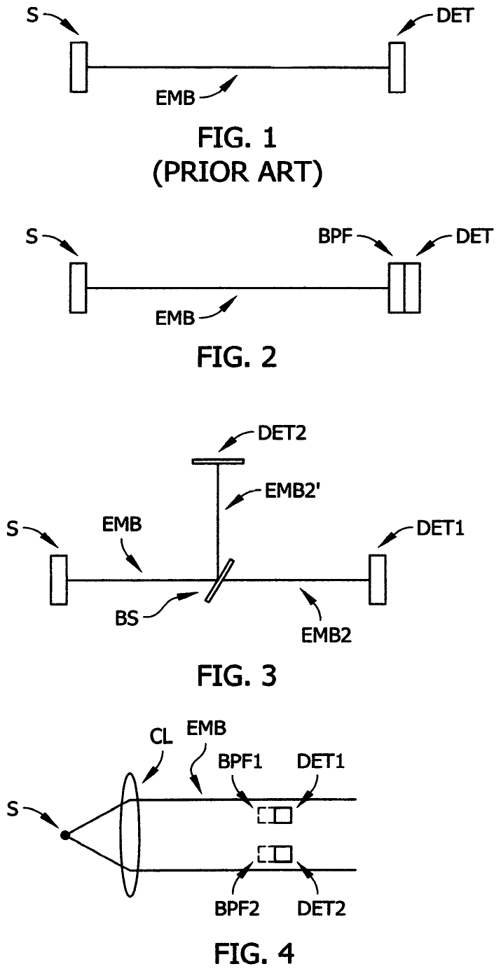

Turning now to the Drawings, FIG. 1 shows a basic Prior Art system for measuring the Energy or the Time it is measured, regarding an Electromagnetic Beam (EMB). In use the Source (S) directs a Beam of Electromagnetic Radiation (EMB) toward a Detector (DET) thereof, which can be configured to measure the Time the Beam is measured, or the Energy thereof, but according to the Heisenberg Uncertainty Principle. Said System can used in the Present Invention to determine Energy (ie. the Wavelength) of the Beam of Electromagnetic Radiation (EMB).

FIG. 2 shows a Present Invention System for measuring both the Time and Energy regarding a Beam of Electromagnetic Radiation (EMB). Note the addition of a Band Pass Filter (BPF) at the input to the Detector (DET), which in use is configured to measure the Time the Beam is measured. The Band Pass Filter limits the Wavelength of the Beam of Electromagnetic Radiation entered into the Detector (DET). Note than an array of such systems could be fashioned which receives a Beam of Electromagnetic Radiation (EMB) of arbitrary Energy content. Each member of the Array can be fashioned with different Band Pass Filters so that if the arbitrary Energy Content Beam contains the Wavelength it passes, then the Time of its arrival can be measured by the associated Detector (DET), with no Uncertainty. However, the Energy will be known upon that measurement of Time as it was the only Energy that could pass to the Detector (DET) through the associated Band Pass Filter. It is pointed out that said Energy is known with better than Infinite Uncertainty. This might not negate the Uncertainty Principle per se., but it does go some distance to Overcoming the problems it poses.

FIG. 3 is included to suggest that a Beam Splitter (BS) can be positioned to enable two Detectors (DET1) (DET2) to receive electromagnetic radiation (EMB2) (EMB2′), one of said Detectors being applied to measure Time and the other Energy simultaneously.

FIG. 4 shows another alternate system involving a Beam (EMB) Collimating Lens (CL) that sends a Beam along to two Detectors (DET1) (DET2) which both intercept the Beam. As in the case of the FIG. 3 system, one of said Detectors is applied to measure Time and the other Energy, simultaneously. It is to be appreciated that each of the Detectors (DET1) and (DET2) can have Bandpass Filters (BPF1) and (BPF2) at their inputs to require specific Electromagnetic Beam Energy levels in order to gain access to the respective Detectors. Thus one could present an array of such Detector-Bandpass Filter combinations with a Beam of random Electromagnetic radiation Energies, and detect them separately.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in breadth and scope only by the Claims.

I claim:

1. A method of determining both energy and time of measurement regarding an electromagnetic beam of radiation simultaneously, comprising the steps of:
a) providing a source of a beam of electromagnetic radiation;
b) providing a detector of electromagnetic radiation, said detector comprising at its entry an effective band-pass filter which only passes a wavelength in a beam of electromagnetic radiation impinging thereonto;
c) causing said source of a beam of electromagnetic radiation to direct a beam of electromagnetic radiation toward said combination detector/bandpass filter at a time T1;
d) monitoring said detector for a signal that said beam is detected thereby establishing a time T2;
e) displaying the energy value of the beam of electromagnetic radiation detected at time T2.

2. A method as in claim 1, in which step b) involves providing a plurality of detector elements each comprising at its entry an effective band-pass filter that passes a different wavelength than the others and monitoring which provides an output signal.

3. A method as in claim 1, in which, prior thereto the wavelength at which the band pass filter passes said electromagnetic beam is determined by conducting a measurement for energy using a system that does not contain any band pass filter, then provide a band pass filter that passes electromagnetic radiation at that wavelength.

4. A method of determining both energy and time of measurement regarding an electromagnetic beam of radiation simultaneously, comprising the steps of:
a) providing a source of a beam of electromagnetic radiation;
b) providing a detector of electromagnetic radiation;
c) causing said source of a beam of electromagnetic radiation to direct a beam of electromagnetic radiation toward said combination detector and measuring for energy;
d) providing a band pass filter that passes electromagnetic radiation at the wavelength associated with said energy determined in step c) and affixing it to the input of the same detector as provided in step a) or a different detector;
said method then comprising:
e) causing said source of a beam of electromagnetic radiation to direct a beam of electromagnetic radiation toward said combination detector/bandpass filter provided in step d) at a time T1;
d) measuring for a time T2 when said beam is detected by the detector/filter provided in step d), thereby establishing a time T2.

5. A method as in claim 4, which further comprises displaying energy of the electromagnetic beam that enters said detector by subjecting said beam a refraction of diffraction.

6. A method of measuring both energy and time in a beam of electromagnetic radiation comprising:
a) providing a system comprising:
a′) a source of electromagnetic radiation;
a″) a beam splitter; and
a′″) two detectors;
b) causing said source of electromagnetic radiation to direct a beam of electromagnetic radiation toward said beam splitter so that one part of said beam emerges and enters one detector and another part thereof emerges and enters the other detector;
c) causing one of said detectors to measure time and the other energy, simultaneously.
